(19) United States
(12) Patent Application Publication
(10) Pub. No.: US 2020/0363673 A1
(43) Pub. Date: Nov. 19, 2020

(54) DISPLAY PANEL AND DISPLAY APPARATUS

(71) Applicant: SHARP KABUSHIKI KAISHA, Sakai City (JP)

(72) Inventor: HIROAKI ISOBE, Sakai City (JP)

(21) Appl. No.: 16/874,273

(22) Filed: May 14, 2020

Related U.S. Application Data
(60) Provisional application No. 62/849,736, filed on May 17, 2019.

(51) Int. Cl. G02F 1/1345

(52) U.S. Cl. CPC G02F 1/13458

(57) ABSTRACT

A display panel includes: an array substrate that includes a display area in which an image is displayed and a non-display area which has a picture-frame shape and which surrounds the display area; and a counter substrate a dimension of which is smaller than a dimension of the array substrate and which is bonded to the array substrate so as to face each other and includes a transparent conductive film on a surface opposite to a surface facing the array substrate, in which a partial area of the non-display area in the array substrate is a wide portion a dimension of which is wider than a dimension of another area of the non-display area, and the counter substrate includes a ground connection portion that expands toward a side of the wide portion and is connected to a ground.

### CROSS-REFERENCE TO RELATED APPLICATION

The present application claims priority from Provisional Application No. 62/849,736, the content to which is hereby incorporated by reference into this application.

### BACKGROUND OF THE INVENTION

### 1. Field of the Invention

The present invention relates to a display panel and a display apparatus.

### 2. Description of the Related Art

In recent years, a transverse electric field type, such as an IPS type or an FFS type, which is excellent in visual characteristics has been adopted for a liquid crystal display apparatus. Such a liquid crystal display apparatus of the transverse electric field type is configured so that a pair of electrodes are arranged on one side (TFT substrate side) of a pair of substrates arranged so as to face each other, and that, when an electric field which drives liquid crystal is generated between the pair of electrodes, the liquid crystal is aligned. That is, a configuration in which an electrode (counter electrode) is not provided in a counter substrate (CF substrate) that is the other substrate is provided. Therefore, there is a problem that, when the counter substrate is charged, electricity is not able to be removed, a voltage generated due to charging is applied to the liquid crystal, and thus a display defect is easily caused. In order to deal with such a problem, techniques described below are proposed.

### SUMMARY OF THE INVENTION

In Japanese Unexamined Patent Application Publication No. 2012-220677, a technique is disclosed in which a transparent conductive film of ITO (Indium Tin Oxide) or the like is formed as a shield layer on an outer surface of a CF substrate, and an earth pad that is earth-connected to an inner surface of a TFT substrate is formed. The transparent conductive film and the earth pad are connected by a conductive tape to thereby discharge static electricity accumulated on a CF substrate side and achieve antistatic performance. Moreover, a method of connecting the transparent conductive film and the earth pad by a conductive paste or the like instead of the conductive tape is also considered. Further, also in International Publication No. 2014/208128, a configuration is disclosed in which a conductive film provided on a surface of a CF substrate and a ground member, such as a chassis or a frame, by which grounding is able to be achieved are conductively connected.

However, in both of the above-described configurations, an area for connection, by which conductivity with the conductive tape or the like is achieved, is required to be ensured on the transparent conductive film of the CF substrate. Such an area for connection is provided in a non-display area that is provided around a display area in which an image is displayed and has a picture-frame shape. Accordingly, there is a problem that it is difficult for the non-display area to have a narrow picture-frame.

An aspect of the invention is accomplished in view of the aforementioned circumstances, and aims to provide a display panel and a display apparatus that enable a non-display area to have a narrow picture-frame.

(1) An embodiment of the invention is a display panel including: an array substrate that includes a display area in which an image is displayed and a non-display area which has a picture-frame shape and which surrounds the display area; and a counter substrate a dimension of which is smaller than a dimension of the array substrate and which is bonded to the array substrate so as to face each other and includes a transparent conductive film on a surface opposite to a surface facing the array substrate, in which a partial area of the non-display area in the array substrate is a wide portion a dimension of which is wider than a dimension of another area of the non-display area, and the counter substrate includes a ground connection portion that expands toward a side of the wide portion and is connected to a ground.

(2) Moreover, another embodiment of the invention is the display panel, in which the ground connection portion is provided on an end part of the wide portion in a direction in which the wide portion extends, in addition to a configuration of (1) described above.

(3) Moreover, another embodiment of the invention is the display panel, in which a ground pad by which grounding is able to be achieved is provided on the wide portion at a position adjacent to the ground connection portion, and the ground connection portion and the ground pad are connected by a conductive member provided so as to spread over the ground connection portion and the ground pad, in addition to a configuration of (1) or (2) described above.

(4) Moreover, another embodiment of the invention is a display apparatus including: the display panel of any one of (1) to (3) described above; and an illumination device that supplies light to the display panel.

(5) Moreover, another embodiment of the invention is the display apparatus, in which the ground connection portion of the display panel is connected to a ground member which is provided in the illumination device and by which grounding is able to be achieved, in addition to a configuration of (4) described above.

According to the embodiment of the invention, a display panel and a display apparatus that enable a non-display area to have a narrow picture-frame are obtained.

### BRIEF DESCRIPTION OF DRAWINGS

FIG. 1 is a plan view of a liquid crystal panel of Embodiment 1 in a state where a polarizing plate is excluded.

FIG. 2 is a front view of the liquid crystal panel.

FIG. 3 is a right side view of the liquid crystal panel.

FIG. 4 is a perspective view of the liquid crystal panel.

FIG. 5 is an enlarged perspective view of a ground connection portion.

FIG. 6 is a sectional view illustrating a schematic configuration in a display area of the liquid crystal panel.

FIG. 7 is a sectional view illustrating a connection structure of the ground connection portion and a ground pad.

FIG. 8 is a sectional view illustrating a liquid crystal display apparatus of Embodiment 2 in a partially enlarged manner.

FIG. 9 is a plan view of a liquid crystal panel of (1) of other embodiments in a state where a polarizing plate is excluded.

FIG. 10 is an enlarged perspective view of a ground connection portion.

FIG. 11 is a plan view of a liquid crystal panel of (2) of the other embodiments in a state where a polarizing plate is excluded.

FIG. 12 is an enlarged perspective view of a ground connection portion.

FIG. 13 is a plan view of a liquid crystal panel of (3) of the other embodiments in a state where a polarizing plate is excluded.

FIG. 14 is a sectional view illustrating a connection structure of a ground connection portion and a ground pad of (4) of the other embodiments.

FIG. 15 is a sectional view illustrating a liquid crystal display apparatus of (5) of the other embodiments in a partially enlarged manner.

FIG. 16 is a sectional view illustrating the liquid crystal display apparatus of (5) of the other embodiments in a partially enlarged manner.

### DETAILED DESCRIPTION OF THE INVENTION

### Embodiment 1

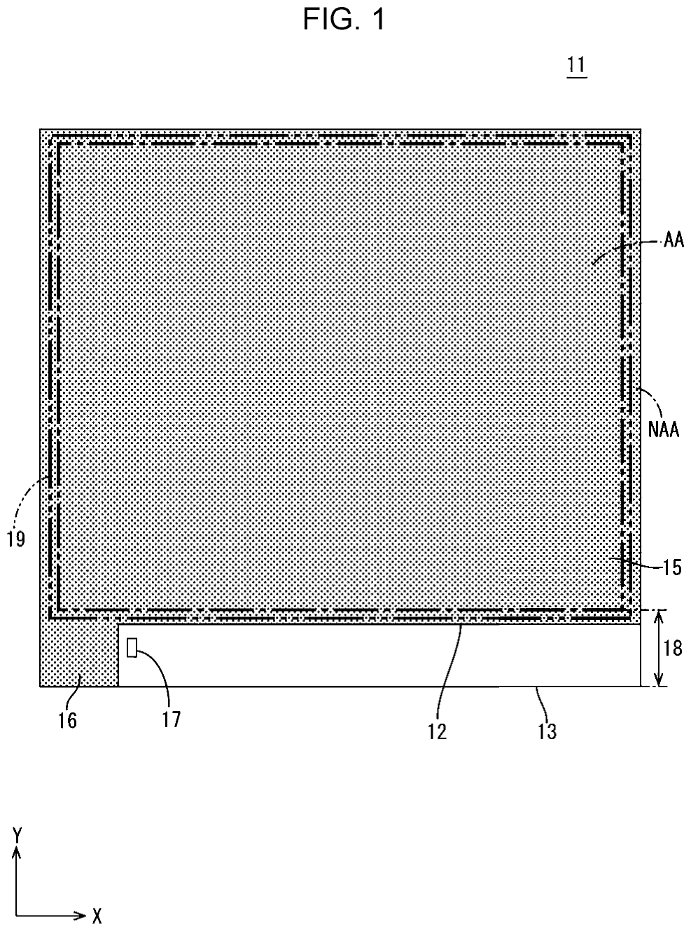

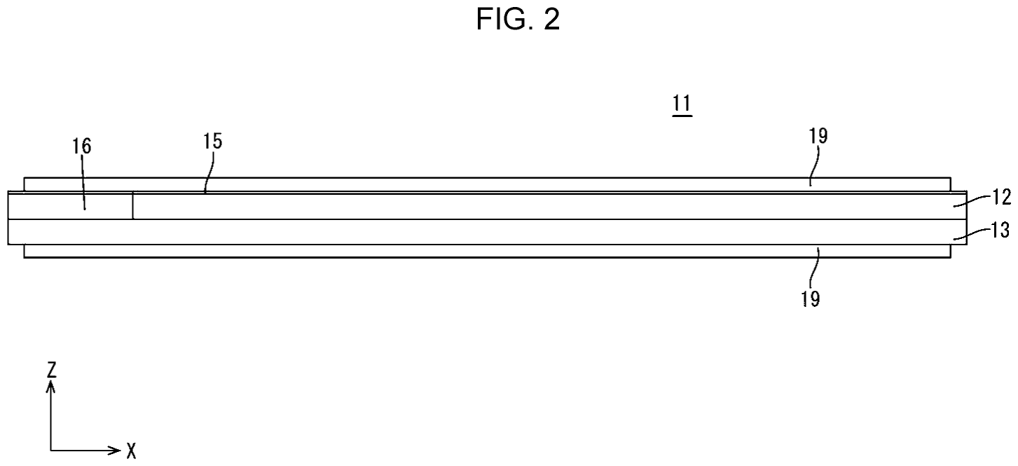

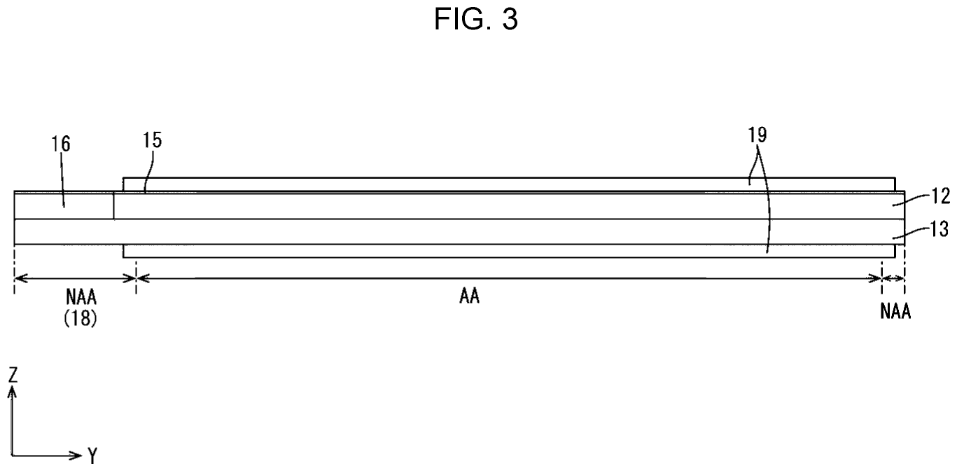

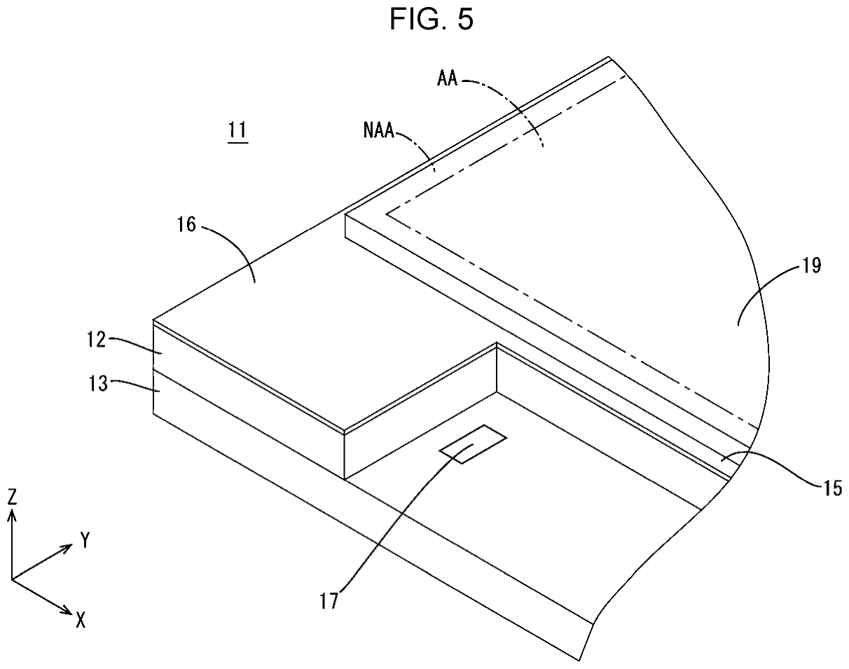

A liquid crystal panel 11 of Embodiment 1 will be described with reference to FIGS. 1 to 7. Some of an X-axis, a Y-axis, or a Z-axis are indicated in each of the figures, and a direction of each axis is illustrated so as to correspond a direction indicated in each figure. FIG. 1 is set as reference of a left-right direction, and a lower side of the figure is set as a front. FIGS. 2 and 3 are set as reference of an up-down direction, and an upper side of each of the figures is set as a front side and a lower side of each of the figures is set as a rear side.

The liquid crystal panel 11 of the present embodiment is used for various types of electronic equipment, such as a portable information terminal (e.g. a cellular phone, a smartphone, or a personal computer of a tablet type), a vehicle-mounted information terminal (e.g. a stationary car navigation system or a portable car navigation system), and a portable game machine. Note that, the liquid crystal panel 11 of the present technique may be applied for various uses without limitation to the aforementioned use.

As illustrated in FIG. 1, in the liquid crystal panel 11 that has a quadrangular shape (rectangular shape) which is long from side to side to some extent as a whole, a display area (active area) AA in which an image is displayed is arranged at a position which is close to one side (upper side illustrated in FIG. 1) of a pair of long sides and an area which surrounds the display area AA and has a frame shape is set as a non-display area (non-active area) NAA in which an image is not displayed. In FIG. 1, a one-dot chain line having a frame shape indicates the outline of the display area AA and an area outside the one-dot chain line is the non-display area NAA. In the non-display area NAA, an area along a long side of the other side (area on a lower side illustrated in FIG. 1) is a wide portion 18 a width dimension of which is wider than that of the other area. In the liquid crystal panel 11, a long-side direction coincides with an X-axis direction of each figure, a short-side direction coincides with a Y-axis direction of each figure, and a thickness direction coincides with the Z-axis direction of each figure.

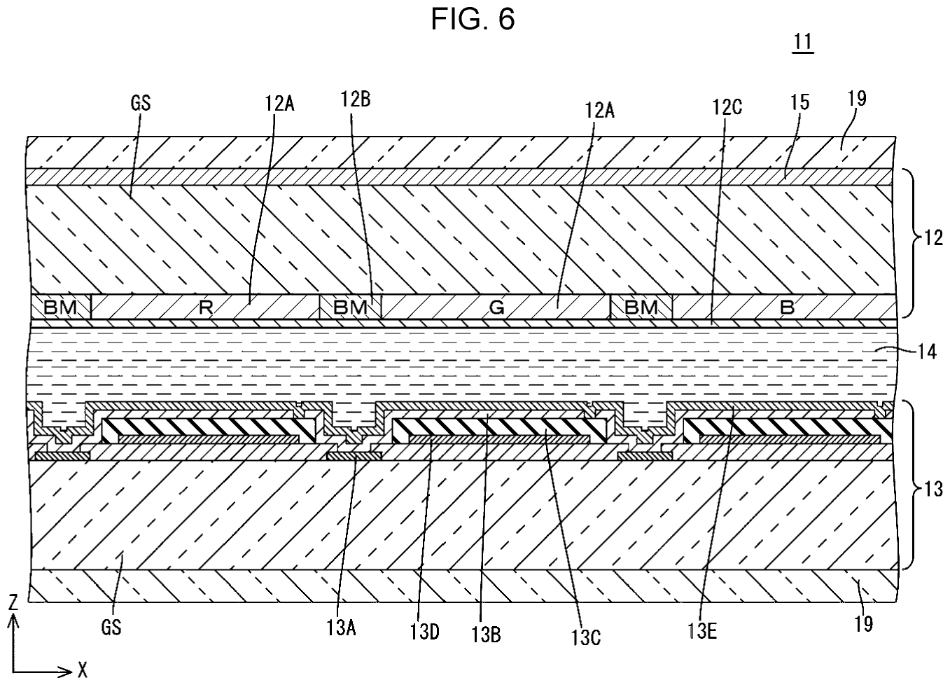

As illustrated in FIG. 6, the liquid crystal panel 11 includes at least a pair of substrates 12 and 13, liquid crystal 14 that is interposed between both of the substrates 12 and 13 and includes a liquid crystal molecule which is a substance whose optical characteristics change in accordance with application of an electric field, and a seal portion that is interposed between both of the substrates 12 and 13, is arranged so as to surround the liquid crystal 14, and seals the liquid crystal 14. In the pair of substrates 12 and 13, a front side one (upper side one of FIG. 6) is set as a CF substrate 12 (example of a counter substrate) and a rear side one (lower side one of FIG. 6) is set as the array substrate 13.

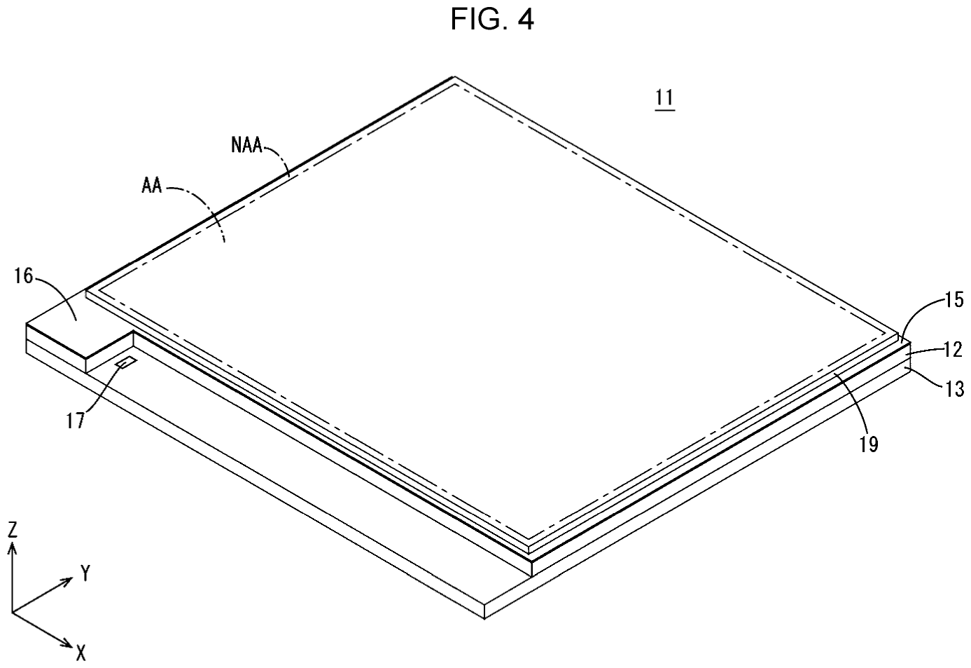

Among them, the CF substrate 12 has a short-side dimension shorter than that of the array substrate 13 and is bonded to the array substrate 13 in a state where end parts on one side (upper-side of FIG. 1, upper-right-side of FIG. 2) in one of the pair of long-sides are lined up, as illustrated in FIG. 4. Accordingly, an end part on the other side (lower-side of FIG. 1, lower-left-side of FIG. 2) of the array substrate 13 in one of the pair of long-sides does not overlap with the CF substrate 12 over a predetermined range, and both front and rear plate surfaces are exposed to the outside. An area of the array substrate 13, in which the front and rear plate surfaces are exposed, is included in the above-described wide portion 18. Moreover, the area is secured for a mounting area of a flexible substrate and a driver. That is, a plurality of terminal portions that are electrically connected to the flexible substrate and the driver are provided in the area. The driver is directly mounted on the mounting area in the array substrate 13 by using COG (Chip On Glass) technology, and able to supply, to a gate line and a source line described below, each output signal generated by processing various input signals supplied from a control circuit substrate via the flexible substrate.

Moreover, a polarizing plate 19 is bonded to each of outer surfaces of both of the substrates 12 and 13. Similarly to the substrates 12 and 13, each polarizing plate 19 has a quadrangular shape, which is long from side to side to some extent, in plan view, and a long-side dimension and a short-side dimension thereof are slightly shorter than a long-side dimension and the short-side dimension of each of the substrates 12 and 13. In FIG. 1, a two-dot chain line having a frame shape indicates the outline of the polarizing plate 19.

Subsequently, a configuration of the display area AA in the array substrate 13 and the CF substrate 12 will be described. As illustrated in FIG. 6, in the array substrate 13, a large number of TFTs (Thin Film Transistors) 13A which are switching elements and a large number of pixel electrodes 13B are provided side by side in a matrix on a glass substrate GS, and gate lines and source lines that form a lattice shape are provided so as to surround the TFTs 13A and the pixel electrodes 13B. To such signal lines, a predetermined image signal is supplied from the control circuit substrate. Each of the pixel electrodes 13B is formed by a transparent electrode of ITO (Indium Tin Oxide), ZnO (Zinc Oxide), IZO (Indium Zink Oxide), or IGZO (Indium Gallium Zink Oxide). A predetermined voltage according to gray scale of a display image is applied to the pixel electrode 13B via a corresponding one of the TFTs 13A at given timing.

In a lower layer of the pixel electrodes 13B, a common electrode 13D that is formed by a transparent electrode film similarly to the pixel electrode 13B is provided via an insulating layer 13C. In this manner, in the array substrate 13, the pixel electrodes 13B and the common electrode 13D are formed together, and, when a potential difference is generated between both of the electrodes 13B and 13D, a fringe electric field that includes a component in a direction normal to the plate surface of the array substrate 13 in addition to a component along a direction of the plate surface of the array substrate 13 is applied to the liquid crystal 14. That is, an operation mode of the liquid crystal panel 11 is an FFS (Fringe Field Switching) mode. Furthermore, for example, a polyimide film serving as an alignment film 13E is formed on a front surface (upper surface in FIG. 6) of the array substrate 13 so as to cover the TFTs 13A and the pixel electrodes 13B.

On the other hand, in the CF substrate 12, color filters 12A are provided at positions that face the respective pixel electrodes 13B on a glass substrate GS on an array substrate 13 side. The color filters 12A are configured so that colored portions of three colors of R (red), G (green), and B (blue) are repeatedly arrayed side by side in a matrix. The respective colored portions (respective pixels) of the color filters 12A, which are arrayed in the matrix, are partitioned by a light shielding portion (black matrix) 12B, and the light shielding portion 12B prevents mixture of colors that is caused when light of the respective colors, which is transmitted through the colored portions, is mixed. Moreover, in the CF substrate 12, PSs (photo spacers) by which a gap between the CF substrate 12 and the array substrate 13 is kept to be a predetermined interval and the liquid crystal 14 is held and each of which has a columnar shape are arranged in the light shielding portion 12B in a predetermined density. Furthermore, an alignment film 12C is provided on a front surface (lower surface in FIG. 6) of the CF substrate 12. Note that, no electrode is provided in the CF substrate 12.

As described above, in the liquid crystal panel 11 according to the present embodiment, the operation mode is the FFS mode which is one of transvers electric field types, and a configuration in which the pixel electrodes 13B and the common electrode 13D by which an electric field is applied to the liquid crystal 14 are arranged only on the array substrate 13 side and such an electrode is not arranged on a CF substrate 12 side is provided. Therefore, the front surface of the CF substrate 12 is easily charged by static electricity generated during a process of manufacturing the liquid crystal panel 11 or a process of manufacturing a liquid crystal display apparatus, and there is a possibility that, when such charging occurs, a vertical electric field which is out of control is generated, the electric field, which is applied to the liquid crystal 14 by the TFT 13A, is disturbed by the vertical electric field, and a display defect is caused.

In order to solve such a problem, on an outer (side opposite to the array substrate 13) plate surface of the CF substrate 12, a conductive film 15 (example of a transparent conductive film) by which antistatic performance is achieved is formed. The conductive film 15 is formed of a transparent electrode material such as ITO or ZnO similarly to the pixel electrodes 13B and the common electrode 13D, and is formed into a pattern having a flat shape over an almost entire area in the plate surface of the CF substrate 12. A most part of the conductive film 15 on a center side, which excludes an outer peripheral end part thereof, is covered with the polarizing plate 19 that is laminated on the front side. Similarly to each of the substrates 12 and 13, each polarizing plate 19 has the quadrangular shape which is long from side to side in plan view and, as described above, the long-side dimension and the short-side dimension thereof are slightly shorter than the long-side dimension and the short-side dimension of each of the substrates 12 and 13.

In a case where the conductive film 15 is connected to a ground, an area for connection in which the conductive film 15 is exposed to the outside is required to be ensured. However, since such an area for connection is the non-display area NAA, in a case where the area for connection is provided, there is a problem that it is difficult for the non-display area NAA to have a narrow picture-frame. Then, in the present embodiment, a configuration in which a ground connection portion 16 that expands toward a wide portion 18 side is provided in the CF substrate 12 is provided. As illustrated in FIGS. 1 and 4, the ground connection portion 16 is provided so as to overlap with a part of the wide portion 18 in the non-display area NAA in the array substrate 13 (liquid crystal panel 11), and has a rectangular shape that expands from an end (left end in FIG. 1) of an outer peripheral edge part of the CF substrate 12 in the X-axis direction toward the wide portion 18 side and extends to an edge part of the array substrate 13 in the Y-axis direction. In other words, in an end part in an extending direction (X-axis direction) of the wide portion 18, the ground connection portion 16 extends to the edge part in a direction (Y-axis direction) orthogonal to the extending direction. The above-described conductive film 15 is formed also on an upper surface of the ground connection portion 16. The ground connection portion 16 is used for conductive connection of the conductive film 15 of the CF substrate 12 with the ground, and the conductive connection with the ground allows charge accumulated in the CF substrate 12 to be discharged to the ground. Note that, the above-described polarizing plate 19 does not cover the ground connection portion 16, and the conductive film 15 of the ground connection portion 16 is exposed to the outside.

On the other hand, in the above-described wide portion 18 of the array substrate 13, a ground pad 17 is provided at a position adjacent to the ground connection portion 16. The ground pad 17 is connected with a ground portion, which is provided in the control circuit substrate and connected to the ground to be always kept at ground potential, via the flexible substrate.

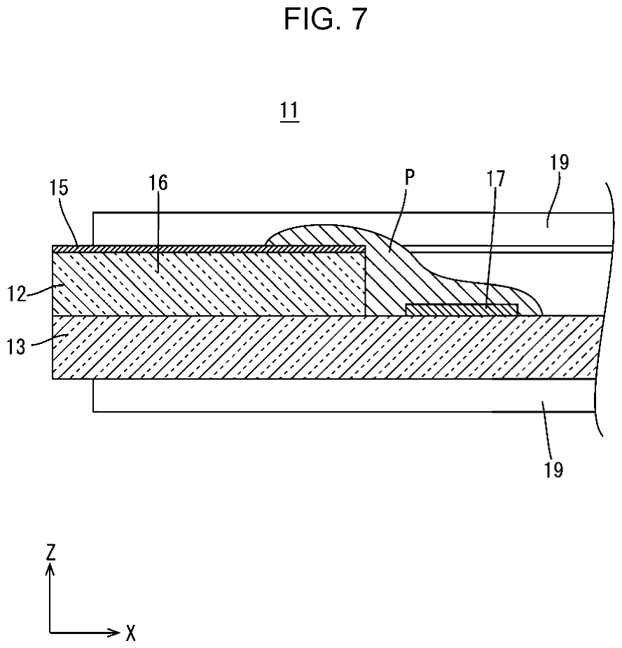

The above-described conductive film 15 of the ground connection portion 16 of the CF substrate 12 and the ground pad 17 are conductively connected by a conductive paste P (example of a conductive member) that is arranged so as to spread over the conductive film 15 and the ground pad 17 (refer to FIG. 7). Thereby, charge accumulated on the CF substrate 12 flows onto the ground pad 17 via the conductive paste P and is discharged to the ground from the ground pad 17 via the flexible substrate and the ground portion of a control circuit substrate.

The liquid crystal panel 11 of the present embodiment has the aforementioned configuration. Next, an acting effect will be described. The liquid crystal panel 11 of the present embodiment includes the array substrate 13 that includes the display area AA in which an image is displayed and the non-display area NAA which has a picture-frame shape surrounding the display area AA, and the CF substrate 12 a dimension of which is smaller than that of the array substrate 13 and which is bonded to the array substrate 13 so as to face each other and includes the conductive film 15, which is transparent, on a side opposite to a surface facing the array substrate 13, in which a partial area of the non-display area NAA in the array substrate 13 is the wide portion 18 the dimension of which is wider than that of the other area of the non-display area NAA, and the CF substrate 12 includes the ground connection portion 16 that expands toward the wide portion 18 side and is connected to the ground.

According to the aforementioned configuration, the ground connection portion 16 provided in the wide portion 18 which is originally the non-display area NAA may be used as the area for connection by which the conductive film 15 of the CF substrate 12 and the ground are connected, so that it is not necessary to take the trouble to widen the non-display area NAA in order to secure an area by which connection with the ground is performed. That is, it is possible to enable the non-display area NAA to have a narrow picture-frame.

Moreover, the above-described ground connection portion 16 is provided in the end part in the extending direction (X-axis direction) of the wide portion 18, and is therefore difficult to disturb the other terminals provided in the wide portion 18, so that disturbance of the driver and the flexible substrate that are connected to the liquid crystal panel 11 is suppressed.

Further, in the present embodiment, the ground pad 17 by which grounding is able to be achieved is provided in the wide portion 18 at the position adjacent to the ground connection portion 16, and the ground connection portion 16 and the ground pad 17 are connected by the conductive paste P provided so as to spread over the both, so that it is possible to simply configure the liquid crystal panel 11.

### Embodiment 2

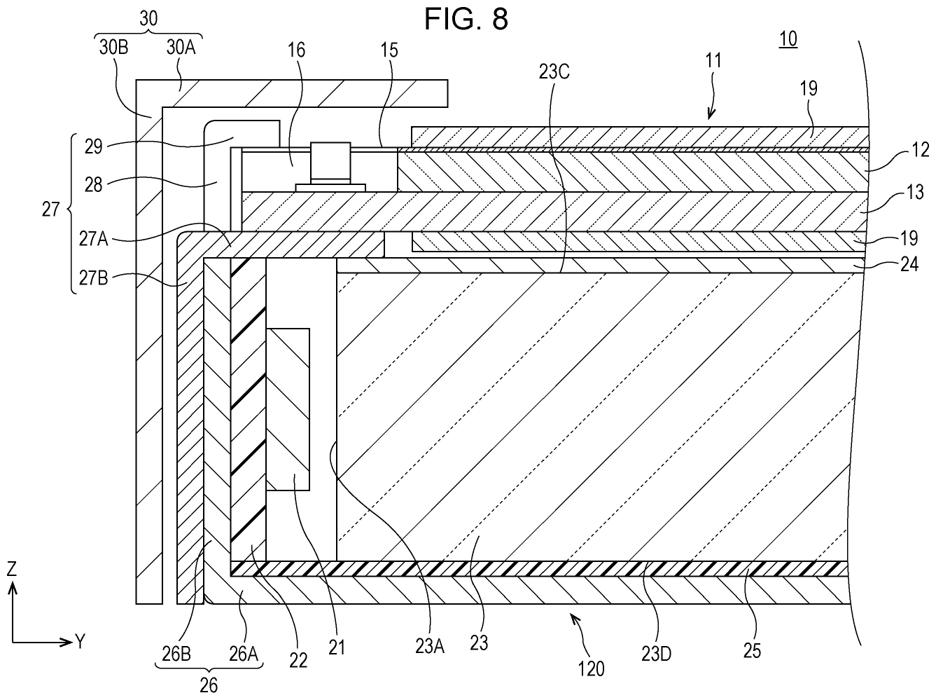

Next, Embodiment 2 will be described with reference to FIG. 8. The present embodiment is related to a liquid crystal display apparatus 10 that includes the liquid crystal panel 11 which is configured similarly to Embodiment 1, except that the ground pad 17 is not provided in the wide portion 18, and that is configured so that connection with the ground is performed when the conductive film 15 of the ground connection portion 16 is conductively connected to a part of the liquid crystal display apparatus 10. Since the liquid crystal panel 11 is similar to that of Embodiment 1 described above, except that the ground pad 17 is not provided, the same reference sings will be given and redundant description will be omitted.

The liquid crystal display apparatus 10 will be described. The liquid crystal display apparatus 10 has a quadrangular shape which is long from side to side as a whole, and is configured by including at least the liquid crystal panel 11 and a backlight device (illumination device) 20 that is an external light source which supplies light to the liquid crystal panel 11. The backlight device 20 has a substantially block shape, which is a rectangle in plan view, as a whole. The backlight device 20 includes a plurality of LEDs 21 (Light Emitting Diodes) that are light sources, an LED substrate 22 on which the LEDs 21 are mounted, a light guiding plate 23 that guides light emitted from the LEDs 21, a plurality of optical sheets 24 that are arranged and laminated on a front side of the light guiding plate 23, a reflection sheet 25 that is arranged and laminated on a rear side of the light guiding plate 23, a chassis 26 that collectively stores these members and has a substantially box shape which is open toward a liquid crystal panel 11 side, a frame 27 that collectively holds these members in the chassis 26, and a bezel 30 that covers an end part of the liquid crystal panel 11.

The backlight device 20 is an edge light type (side light type) one of a single-side light entering type in which the LEDs 21 are arranged on an end surface on one long-side side of the light guiding plate 23 and thereby light enters the light guiding plate 23 only from a single side. The backlight device 20 converts light from the LEDs 21 into light in a plane shape and emits the resultant from an opening of the chassis 26 toward the liquid crystal panel 11 which is on the front side. That is, a front side of the backlight device 20 is set as a light emitting side. Hereinafter, constituents of the backlight device 20 will be described in order.

Each of the LEDs 21 is configured by sealing, with a resin material, an LED chip (LED element), which is a semiconductor light emitting element, on a substrate portion which is fixed to a plate surface of the LED substrate 22 described below. A main light emission wavelength of the LED chip mounted on the substrate portion is one type, and, specifically, one that emits light of a single color of blue is used. On the other hand, in the resin material that seals the LED chip, phosphors each of which is excited by the blue light emitted from the LED chip and emits light of a predetermined color are dispersed and compounded, and the LED 21 emits substantially white light as a whole. The LED 21 is a so-called top-view type (top surface light emitting type, upper surface light emitting type) one in which a light emitting surface from which light is emitted faces a side opposite to an LED substrate 22 side.

In the LED substrate 22, a wiring pattern by which electricity is supplied to the LEDs 21 is formed on a base film formed of thermosetting resin such as urethane resin or epoxy resin and a thermoplastic resin layer of, for example, polyimide resin or the like which has thermoplasticity is laminated, and the plurality of LEDs 21 are surface-mounted on the thermoplastic resin layer so as to be arrayed intermittently. The LED substrate 22 is arranged so that light emitting surfaces of the LEDs 21 are parallel to a long-side side end surface (light incident surface 23A) of the light guiding plate 23 described below.

The light guiding plate 23 is formed of transparent synthetic resin, such as acrylic resin or polycarbonate, or the like, has a plate shape of an approximate rectangle in plan view, which is one size smaller than a bottom plate portion 26A of the chassis 26 described below, and is arranged in parallel to the bottom plate portion 26A of the chassis 26. Moreover, a long-side direction (length direction) and a short-side direction (width direction) of the light guiding plate 23 respectively coincide with the X-axis direction and the Y-axis direction and a plate thickness direction which is orthogonal to a plate surface of the light guiding plate 23 coincides with a Z-axis direction. The light guiding plate 23 is stored in the chassis 26 so that a periphery of the light guiding plate 23 is surrounded by standing walls 26B.

In an outer peripheral end surface of the light guiding plate 23, as described above, an end surface on a long-side side, which is on a left side illustrated in FIG. 8, is the light incident surface 23A which faces the light emitting surface of the LED 21 in parallel at a predetermined distance and on which light from the LED 21 is incident, and a surface opposite to the light incident surface 23A is an incidence opposite surface. Moreover, an upper surface (front surface) of a pair of plate surfaces is a light emission surface 23C from which the light incident into the light guiding plate 23 is emitted toward the liquid crystal panel 11, and a lower surface (rear surface) of the pair of plate surfaces is a reflection surface 23D that reflects light, which travels toward the lower surface (rear surface) from an inside of the light guiding plate 23, toward a light emission surface 23C side.

The light guiding plate 23 is arranged at a position immediately under the liquid crystal panel 11 via the optical sheets 24 that are laminated on the light emission surface 23C. Each of the optical sheet 24 has a sheet-like shape which is flat and a rectangle, and a long-side direction and a short-side direction thereof respectively coincide with the X-axis direction and the Y-axis direction. The optical sheets 24 are arranged so as to be interposed between the light guiding plate 23 and the liquid crystal panel 11, and thereby transmit emitted light from the light guiding plate 23 and emit the transmitted light toward the liquid crystal panel 11 while giving a predetermined optical action to the transmitted light.

On the other hand, on a rear surface side (reflection surface 23D side) of the light guiding plate 23, the reflection sheet 25 is laminated. The reflection sheet 25 is formed by a sheet material which is made of synthetic resin and a surface of which shows a white color that is excellent in light reflectivity, and is able to efficiently raise light, which is propagated through the light guiding plate 23 and emitted from the reflection surface 23D, toward the front side (light emission surface 23C).

The chassis 26 is formed by a metal material, for example, such as an aluminum plate or an electro galvanized steel sheet (SECC), has a rectangular shape in plan view and an approximate box shape that is open toward the front side, and stores the LED substrate 22, the light guiding plate 23, and the like in an inside thereof. The chassis 26 is constituted by the bottom plate portion 26A which has a rectangular shape and the standing walls 26B which respectively stand from edge parts (a pair of long sides and a pair of short sides) of the bottom plate portion 26A toward the front side. In the bottom plate portion 26A of the chassis 26, a long-side direction coincides with the X-axis direction, a short-side direction coincides with the Y-axis direction, and a direction orthogonal to a plate surface coincides with the Z-axis direction, and the LED substrate 22 is attached to one of the standing walls 26B, which is on one of long-side sides (left side illustrated in FIG. 8).

The frame 27 is formed by, for example, applying presswork to a metal plate material having conductivity, and is configured to be in a frame shape which is a rectangle in plan view and which is constituted by a light guiding plate pressing portion 27A that presses end portions of the light guiding plate 23 over an entire periphery from the front side (plate surface side) via the optical sheets 24 and side walls 27B each of which protrudes from an outer peripheral edge part of the light guiding plate pressing portion 27A toward the rear side and which surround the chassis 26 from an outer peripheral side. The frame 27 and the chassis 26 are positioned with respect to each other by a locking mechanism. The light guiding plate pressing portion 27A supports an outer peripheral end part of the liquid crystal panel 11 from the rear side.

The bezel 30 is formed by, for example, a metal material such as aluminum, and formed into a frame shape, which is a rectangle, as a whole. The bezel 30 is configured by a panel covering portion 30A that covers end parts of the liquid crystal panel 11 over an entire periphery from the front side and an outer tube portion 30B that protrudes from an outer peripheral edge part of the panel covering portion 30A toward the rear side and surrounds the frame 27 from an outer peripheral side.

As illustrated in FIG. 8, the above-described frame 27 is provided with panel positioning portions 28 each of which has a surface facing a part of an outer peripheral end surface of the liquid crystal panel 11 and which position the liquid crystal panel 11 with respect to directions along a plate surface (the X-axis direction and the Y-axis direction). The panel positioning portion 28 is obtained by partially cutting and raising the light guiding plate pressing portion 27A and a side wall 27B and is thereby formed into a plate piece shape which stands up on the front side of the light guiding plate pressing portion 27A, and a plate surface of the panel positioning portion 28 is orthogonal to the plate surface of the liquid crystal panel 11. A plate surface of the panel positioning portion 28, which faces inside, faces the part of the outer peripheral end surface of the liquid crystal panel 11, and, when coming into contact with the part of the outer peripheral end surface of the liquid crystal panel 11, the plate surface of the panel positioning portion 28 is able to position the liquid crystal panel 11 with respect to the directions along the plate surface. At least one or more panel positioning portions 28 are provided in each of four sides of the frame 27, and, on a side corresponding to the wide portion 18 of the liquid crystal panel 11, the panel positioning portion 28 is provided at least at a position corresponding to the ground connection portion 16.

In the panel positioning portion 28 that is provided at the position corresponding to the ground connection portion 16 of the liquid crystal panel 11, an elastic contact portion 29 that elastically contacts the conductive film 15 of the ground connection portion 16 formed in the CF substrate 12 of the liquid crystal panel 11 is integrally provided. The elastic contact portion 29 protrudes toward an inside from a tip end part of the panel positioning portion 28, which stands up from the light guiding plate pressing portion 27A, and a protrusion tip end part of the elastic contact portion 29 extends to a position overlapping with the conductive film 15 of the ground connection portion 16 in the CF substrate 12 in plan view. The elastic contact portion 29 has an end part, which is connected to the panel positioning portion 28, as a base end part, is constituted by a plate piece having a cantilever shape which has an end part on a side opposite to a panel positioning portion 28 side as a free end part, and has a plate surface which is parallel to a plate surface (the X-axis direction and the Y-axis direction) of the ground connection portion 16. Accordingly, the elastic contact portion 29 is elastically deformable in such a manner that the free end part swings in a direction (Z-axis direction), which intersects with the plate surface of the elastic contact portion 29, with the base end part as a fulcrum. A rear-side plate surface of the elastic contact portion 29 faces a front-side plate surface of the light guiding plate pressing portion 27A, which serves as a supporting surface of the liquid crystal panel 11, and elastically contacts the conductive film 15 of the ground connection portion 16 in the CF substrate 12, which is exposed. Since the elastic contact portion 29 is formed integrally with the frame 27, frame ground (grounding) for the conductive film 15 that is contacted by the elastic contact portion 29 is achieved with respect to the frame 27 that is a ground member which is a large-sized metal component configuring the liquid crystal display apparatus 10 and is able to achieve frame ground, and thus antistatic performance of the liquid crystal panel 11 is achieved and occurrence of a display defect is suppressed.

In this manner, also in the present embodiment, the ground connection portion 16 provided in the wide portion 18 may be used as an area for connection by which the conductive film 15 of the CF substrate 12 and the ground are connected, similarly to the aforementioned embodiment, so that it is not necessary to take the trouble to widen the non-display area NAA in order to secure an area by which connection with the ground is performed. That is, it is possible to enable the non-display area NAA to have a narrow picture-frame.

Moreover, since a configuration in which the ground connection portion 16 is conductively connected to the frame 27 of the backlight device 20 and the liquid crystal panel 11 is integrated with the backlight device 20 to thereby achieve grounding is provided, connection may not be performed by providing a pad for ground connection in the wide portion and a ground portion by which ground connection to the control circuit substrate is performed may not be provided. Furthermore, since the ground connection portion 16 is provided at a position distant from the display area AA, stress in a connection portion by the elastic contact portion 29 is difficult to be applied to the display area AA, resulting in that display unevenness is reduced.

### Other Embodiments

The invention is not limited to the embodiments explained by the aforementioned description and figures, and, for example, the following embodiments are also included in a technical range of the invention.

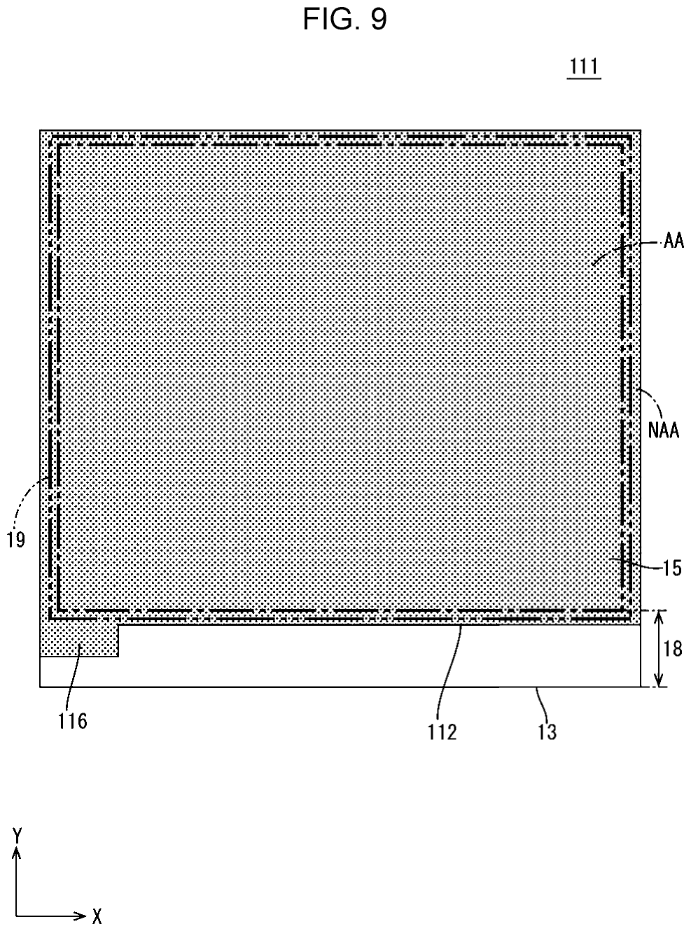

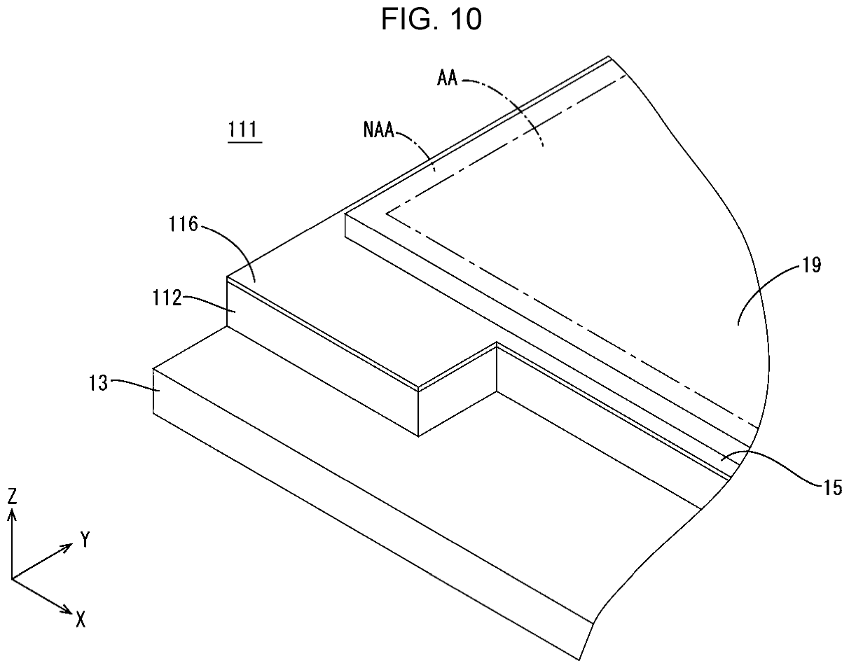

(1) An example of the liquid crystal panel 11, in which the ground connection portion 16 of the CF substrate 12 extends to the end part of the array substrate 13 in the Y-axis direction, is described in the aforementioned embodiments, the ground connection portion does not need to extend to the end part. For example, as illustrated in FIGS. 9 and 10, a liquid crystal panel 111 in which a ground connection portion 116 of a CF substrate 112 expands toward the wide portion 18 side, but does not extend to the end part of the array substrate 13 may be provided. In a case where such a configuration is provided, as compared with Embodiment 1, a wider formation area of a terminal in the wide portion 18 is able to be ensured.

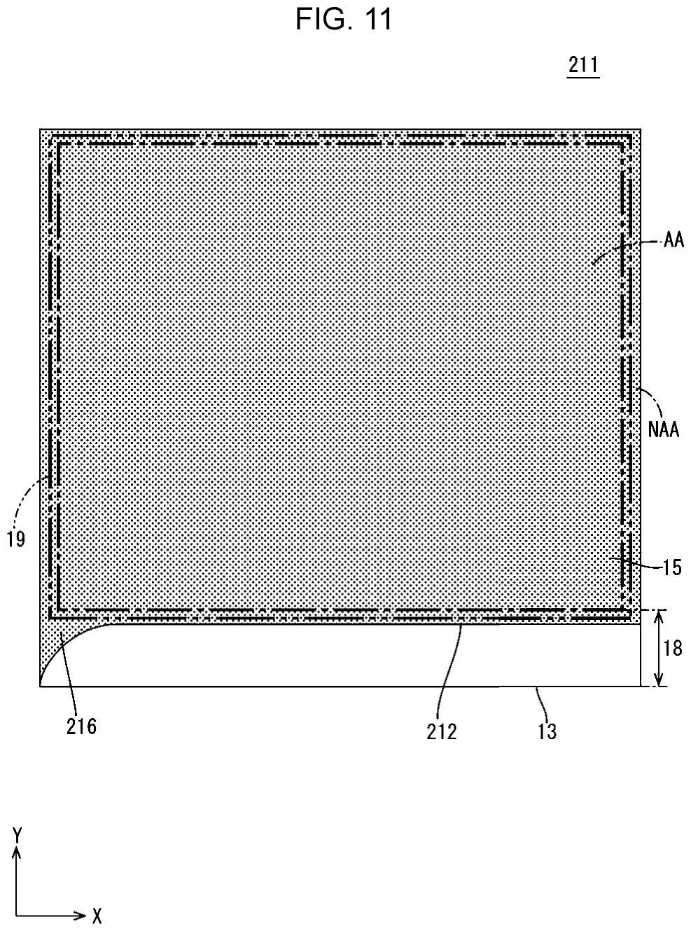

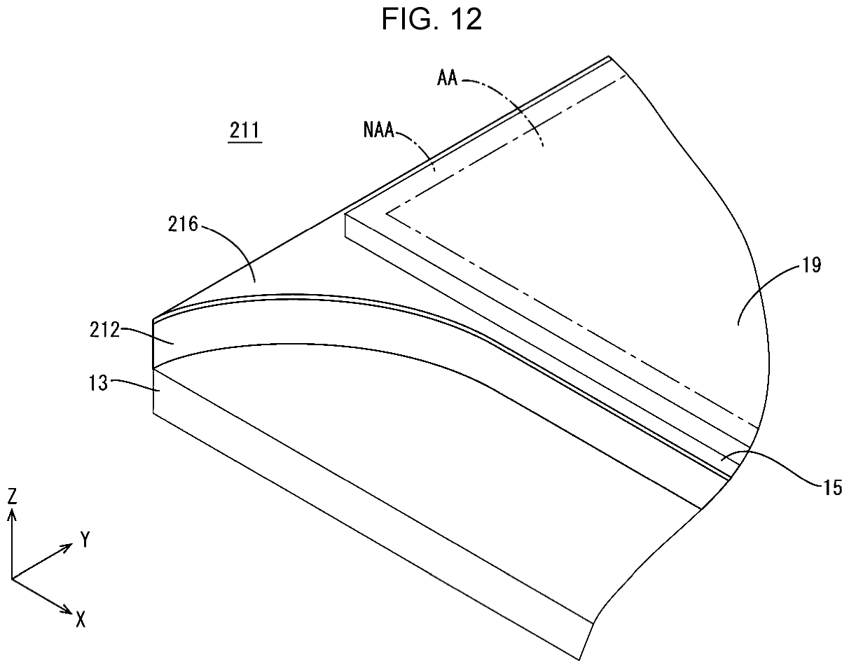

(2) Moreover, the ground connection portion is able to have any form without limitation to a rectangular shape. For example, as illustrated in FIGS. 11 and 12, a liquid crystal panel 211 in which a ground connection portion 216 has a configuration obtained by cutting off a rectangular area into a circular arc shape in plan view may be provided. For such a configuration, for example, a case where, when a CF substrate 212 is divided, dividing is stopped halfway and the CF substrate 212 is divided as things go or the like is assumed.

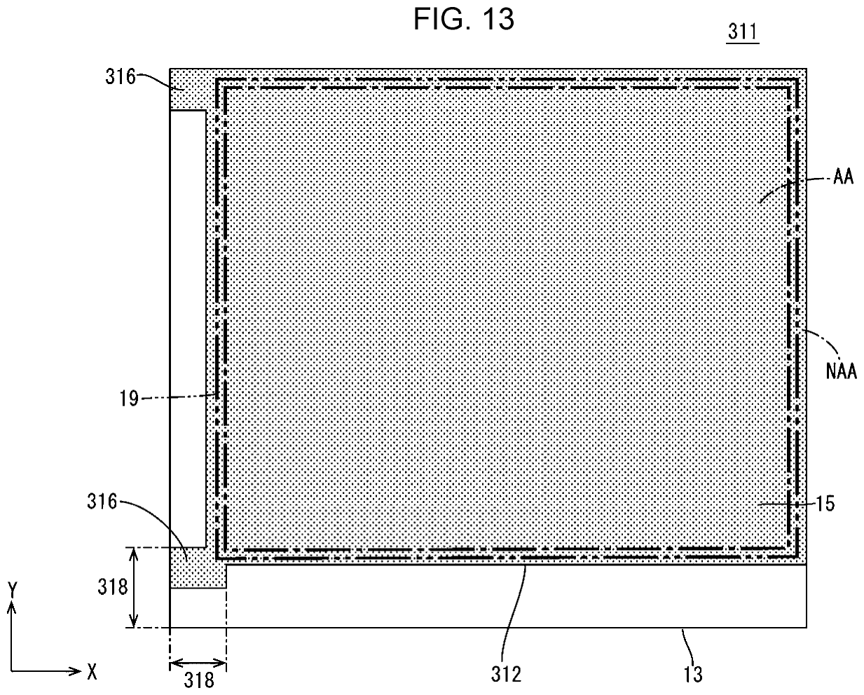

(3) The ground connection portion is able to be provided at any position without limitation to the end part in the extending direction of the wide portion. Moreover, not only one but a plurality of ground connection portions are also able to be provided. For example, as illustrated in FIG. 13, in a case where lengths of a CF substrate 312 are shorter than those of the array substrate 13 both in a long-side direction and in a short-side direction and a wide portion 318 is provided along each of adjacent sides of a liquid crystal panel 311 having a rectangular shape, a ground connection portion 316 is able to be provided at a position where wide portions 318 overlap, or another ground connection portion 316 is able to be further provided.

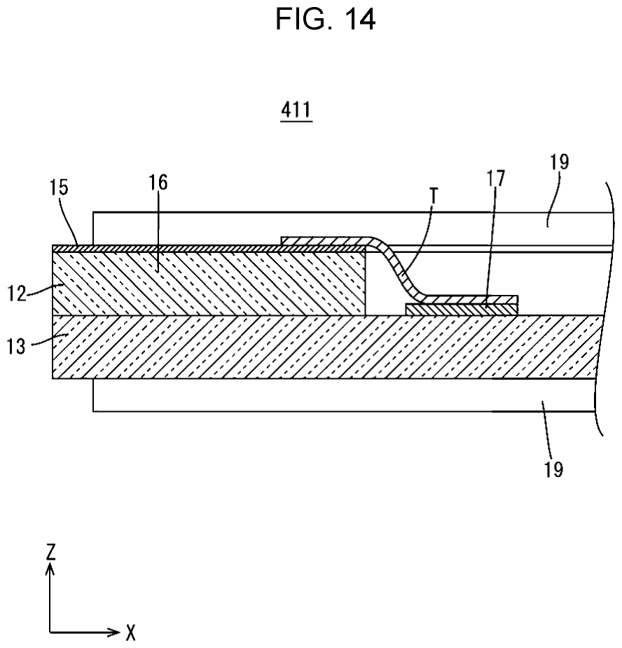

(4) Although a configuration in which the ground connection portion 16 and the ground pad 17 are conductively connected by the conductive paste P is provided in Embodiment 1 described above, a conductive member is not limited to the conductive paste P. For example, as illustrated in FIG. 14, a conductive tape T is able to be used instead of the conductive paste P.

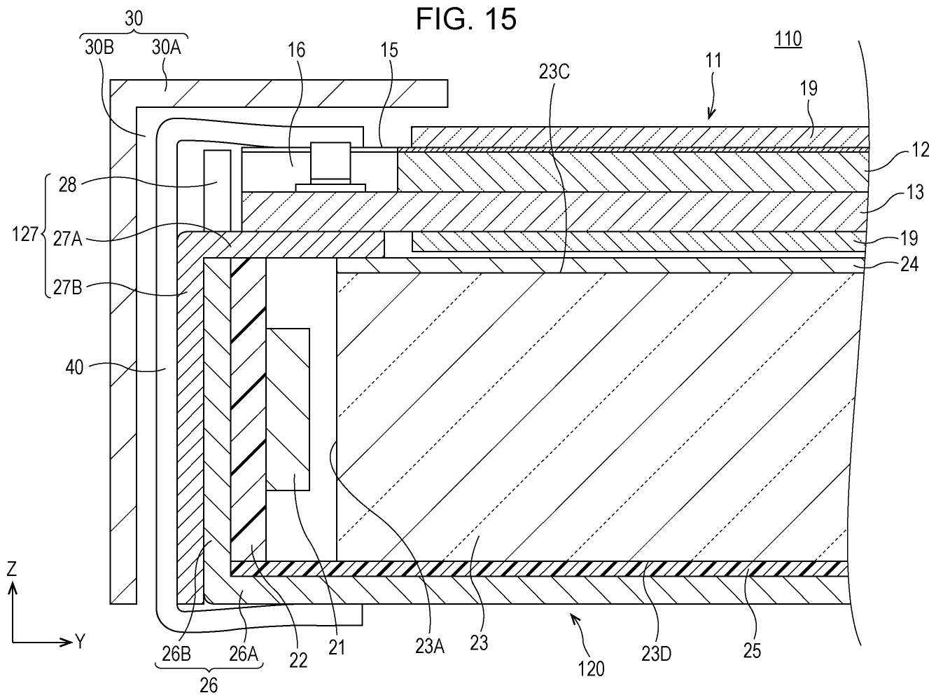

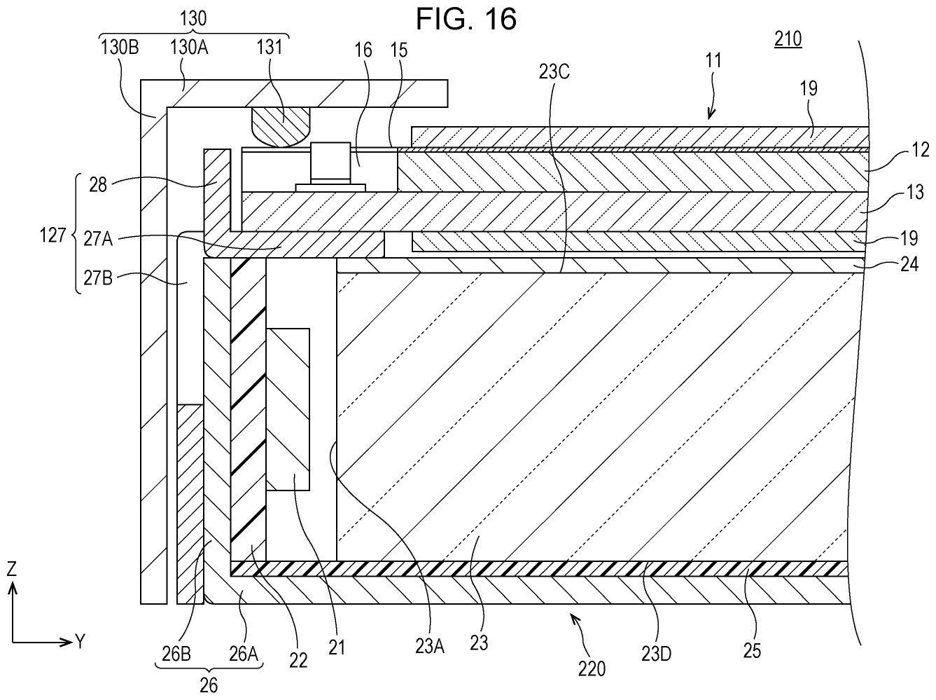

(5) Although an example of the liquid crystal display apparatus 10 in which the ground connection portion 16 is connected to the frame 27 of the backlight device 20 to achieve frame ground is described in Embodiment 2 described above, the ground connection portion may be connected to another ground member in the backlight device. For example, as illustrated in FIG. 15, a liquid crystal display apparatus 110 in which chassis ground is achieved by a backlight device 120 that is attached by a connection member 40, which is obtained by applying presswork to a metal plate material having conductivity into a gate shape, so as to sandwich the ground connection portion 16 and the bottom plate portion 26A of the chassis 26 may be provided. Alternatively, as illustrated in FIG. 16, a liquid crystal display apparatus 210 in which bezel ground is achieved by a backlight device 220 that is provided with a connection protrusion 131, which protrudes toward the ground connection portion 16, on a rear surface of a panel covering portion 130A of a bezel 130 may be provided. In short, any form is able to be provided as long as a configuration in which the ground connection portion 16 is able to be conductively connected to a member capable of achieving grounding is provided.

What is claimed is:

1. A display panel comprising:
an array substrate that includes a display area in which an image is displayed and a non-display area which has a picture-frame shape and which surrounds the display area; and
a counter substrate a dimension of which is smaller than a dimension of the array substrate and which is bonded to the array substrate so as to face each other and includes a transparent conductive film on a surface opposite to a surface facing the array substrate, wherein
a partial area of the non-display area in the array substrate is a wide portion a dimension of which is wider than a dimension of another area of the non-display area, and
the counter substrate includes a ground connection portion that expands toward a side of the wide portion and is connected to a ground.

2. The display panel according to claim 1, wherein the ground connection portion is provided on an end part of the wide portion in a direction in which the wide portion extends.

3. The display panel according to claim 1, wherein a ground pad by which grounding is able to be achieved is provided on the wide portion at a position adjacent to the ground connection portion, and the ground connection portion and the ground pad are connected by a conductive member provided so as to spread over the ground connection portion and the ground pad.

4. A display apparatus comprising: the display panel according to claim 1; and an illumination device that supplies light to the display panel.

5. The display apparatus according to claim 4, wherein the ground connection portion of the display panel is connected to a ground member which is provided in the illumination device and by which grounding is able to be achieved.
